(19) United States
(12) Patent Application Publication
(10) Pub. No.: US 2002/0172757 A1
(43) Pub. Date: Nov. 21, 2002

(54) Automated system for dip coating YBCO films on substrates

(76) Inventors: Christine L. Vrtis, Carpentersville, IL (US); James Sharp, Chicago, IL (US)

Correspondence Address: MARSHALL, GERSTEIN & BORUN, 6300 SEARS TOWER, 233 SOUTH WACKER, CHICAGO, IL, 60606-6357, US

(21) Appl. No.: 09/799,962

(22) Filed: Mar. 6, 2001

(51) Int. Cl. B05D 3/02; B05D 5/12; B05D 1/18

(52) U.S. Cl. 427/100; 427/430.1; 427/376.1; 427/376.2; 505/470; 118/688

(57) ABSTRACT

An automated system for dip coating a superconducting material on a substrate is disclosed. The system includes an actuator, a pick up station, a dip coating station that comprises a reservoir of a dip coating formulation, a drying station that includes a source of heated air and a conveyor for moving the actuator from the pick up station to the dip coating station and from the dip coating station to the drying station. The actuator includes an arm for carrying a substrate. The arm is capable of being moved vertically downward to submerse the substrate in the dip coating reservoir and the arm is also capable of being moved vertically upward to lift the substrate out of the dip coating reservoir. A method for automatically dip coating a substrate with a superconducting material is also disclosed. The method includes the steps of picking up a substrate at a pick up station, conveying the substrate to a dip coating station that includes a reservoir of a dip coating formulation, submersing the substrate in the reservoir of dip coating formulation to form a coating thereon, removing the substrate from the reservoir, conveying the substrate to a drying station that includes a source of heated air, drying the coating of the substrate in the drying station, conveying the substrate from the drying station to a heat processing station and heat processing the substrate.

### FIELD OF THE INVENTION

The present invention relates generally to automated systems for producing superconducting materials, and more particularly to automated systems for manufacturing structures coated with superconducting materials. Still more specifically, the present invention relates to automated systems for dip coating structures with superconducting coatings.

### BACKGROUND OF THE DISCLOSURE

The discovery that certain ceramic materials exhibit superconductivity at above liquid nitrogen temperatures has stimulated intensive research. Once such ceramic material is YBa₂Cu₃O₆₊ₓ where x ranges from 0 to 1 or “YBCO.” Many uses for such materials have been suggested and attempted, including, for example, devices operating with microwave or radio frequency signals such as antennas, magnetic resonance imaging pickup coils, resonators, and the like. Optimal performance of such devices may depend upon having the lowest possible surface resistance.

Low-surface resistance high-temperature superconducting materials have been successfully fabricated in the form of thin films of ceramic. Such films typically have a thickness on the order of 50 μm to 200 μm and are formed by depositing the ceramic material or its precursors on the surface of a planar, single crystal substrates using techniques such as co-evaporation, sputtering, laser ablation, and molecular beam epitaxy. The disadvantages of these techniques are discussed in U.S. Pat. Nos. 5,789,347 and 6,119,025 which disclose a “melt processing” process.

The melt processing process of the '347 and '025 patents involves heating a film that contains YBCO starting materials or precursor materials on a yttria/zirconia ceramic substrate at a temperature above 1015° C. in pure oxygen. The film is applied by doctor blading. The heat treatment is fast and relatively simple, but it cannot be used on metallic substrates due to the extreme temperatures (>1015° C.) required to generate the YBCO in the film. The typical surface resistance of the flat films produced by the melt texture process of the '347 and '025 patents are about 0.1 milliohms while the surface resistance of small diameter curved surfaces, e.g., 1-3 mm diameter, is somewhat higher, about 0.3 milliohms.

U.S. Pat. Nos. 5,340,797 and 5,527,765 disclose a “reactive texture” process which involves forming films on metallic substrates from compounds containing constituents of YBCO. The substrate and films are then heated to near 900° C. which results in a decomposition of the compounds containing constituents of YBCO and the crystallization of YBCO or the substrate. Substrates are typically stainless steel or INCONEL® (a.k.a. PYROMET®) which require thick silver plating before the application of the YBCO film. The heat treatment requires multiple gas changes including a warm-up in carbon dioxide. The dwell is typically performed in a 2 Torr oxygen atmosphere, but it is claimed to work in higher oxygen concentrations all the way up to pure oxygen. The process is very sensitive and can be difficult to control. The films are applied by doctor blading, screen printing, and spin coating.

U.S. Pat. No. 5,856,277 discloses a “surface texture” process which is a way to alter the surface of a bulk pellet of YBCO. The top layer of the resulting structure is typically much thicker than the film produced in the melt texture, surface texture and reactive texture processes discussed above.

The melt process, surface texture and reactive texture processes all utilize some degree of melting and recrystallization. The YBCO grain size in the surface texture process of the '277 patent is typically somewhat smaller than that of the melt process and reactive texture processes, but the surface resistance is about the same as in the other two texturing methods.

Conventional sinter processes use the same substrates and temperatures as the reactive texture process of the '797 and '765 patents but such conventional sinter processes use only phase-pure YBCO and do not involve melting any portion of the film. There is a single gas change at the end of the dwell time at maximum temperature when oxygen concentration is switched from a 1% oxygen atmosphere to a pure oxygen atmosphere. Conventional sinter processes are typically easy to perform but result in films with a resistivity that is significantly higher than that obtained by the melt texture, reactive texture and surface texture processes. However, the surface resistance provided by the conventional sinter processes is superior to that of ordinary conductors such as copper or silver, even at 77° K. Unlike the melt texture, reactive texture and surface texture processes, the YBCO grains produced by the conventional sintering processes are microscopic and randomly oriented, thus resulting in higher surface resistance.

The '347, '025, '797, '765 and '277 patents are all owned by the assignee of the present application and the disclosures of said patents are incorporated herein by reference.

To date, an automated dip coating process or system has not been developed which provides a superconductive coating with a satisfactory resistance that can be applied by a dip coating the substrate into a formulation or “ink.” The development of an automated dip coating process and system would greatly facilitate the fabrication of substrates coated with superconducting materials thereby lowering the cost of products with superconductive coatings.

### SUMMARY OF THE DISCLOSURE

The present invention satisfies the aforenoted needs by providing an automated system for dip coating a superconducting material on a substrate. One disclosed system comprises an actuator, a pick up station, a dip coating station that comprises a reservoir holding a dip coating formulation, a drying station that comprises a source of heated air and a conveyor for moving the actuator from the pick up station to the dip coating station and from the dip coating station to the drying station. One disclosed actuator comprises an arm for carrying a substrate. The arm is capable of being moved vertically downward to submerse the substrate in the dip coating reservoir and the arm is further capable of being moved vertically upward to lift the substrate out of the dip coating reservoir.

In a refinement of the disclosed system, the actuator arm is capable of rotating the substrate. It has been found that rotating the substrate can be helpful while the substrate is being held in the drying station.

In a further refinement of the disclosed system, the drying station comprises an enclosure for circulating heated air from drying the substrate.

In another refinement of the disclosed system, the actuator arm comprises a hydraulic mechanism for vertically raising and lowering the arm.

In another refinement of the disclosed system, the conveying mechanism comprises an endless belt or an endless chain for repeatedly conveying the actuator from the pick up station, to the dip coating station and to the drying station.

In another refinement of the disclosed system, the actuator arm is connected to a perforated tray used to support a plurality of substrates thereby enabling a plurality of substrates to be dip coated and dried in a single pass through the system.

The actuator arm may be threadably connected to a substrate or may magnetically, suctionally or frictionally engage a substrate as it carries a substrate through the dip coating and drying stations.

In a further refinement of the disclose system, the drying station maintains an air temperature of about 90° C.

In another refinement of the disclosed system, the actuator arm rotates the substrate in the drying station at a rate ranging from about 200 rpm to about 400 rpm, preferably about 300 rpm.

The present invention also includes a method for dip coating a superconductor coating on a substrate. One disclosed method comprises picking up a substrate at a pick up station. The substrate is then conveyed to a dip coating station that includes a reservoir of a dip coating formulation. The substrate is then submersed in the dip coating formulation to form a coating thereon. The substrate is then removed from the reservoir and conveyed to a drying station which includes a source of heated air. The substrate is then dried in the drying station to provide a dry coating having a second thickness. The substrate is then conveyed from the drying station to a heat processing station where the substrate is heat processed.

In a refinement of the disclosed method, the thickness of the coating after the drying step is measured. In still a further refinement, if the thickness of the coating after the drying step is unsatisfactory, the coating is removed from the substrate and the method is performed again.

In another refinement, the thickness of the substrate is measured, the thickness of the coating after the drying step is measured and the thickness of the coating after the heat processing step is measured. If either the thickness of the coating after drying step or the thickness of the coating after the heat processing step is unsatisfactory, the coating is removed from the substrate and the process performed again.

In a further refinement, the formulation for the dip coating in the dip coating reservoir comprises: a vehicle comprising from about 57 wt % to about 59 wt % terpineol, from about 37 wt % to about 39 wt % butoxyethyl acetate, and from about 2 wt % to about 5 wt % binder; the vehicle is mixed with phase pure YBa₂Cu₃O₆₊ₓ powder so that the formulation comprises from about 62 wt % to about 64 wt % phase pure YBa₂Cu₃O₆₊ₓ powder, and from about 36 wt % to about 38 wt % vehicle.

In a further refinement, the dip coating formulation for the dip coating reservoir comprises: a vehicle comprising from about 47 wt % to about 49 wt % terpineol, from about 47 wt % to about 49 wt % butoxyethyl acetate, from about 2 wt % to about 4 wt % binder, and the vehicle is mixed with unreacted YBa₂Cu₃O₆₊ₓ precursor material so that the formulation comprises from about 71 wt % to about 73 wt % unreacted YBa₂Cu₃O₆₊ₓ precursor material, and from about 27 wt % to about 29 wt % vehicle.

### BRIEF DESCRIPTION OF THE DRAWINGS

The present invention is described more or less diagrammatically in the accompanying drawings wherein:

FIG. 1 is a schematic diagram illustrating the automated system for dip coating a superconducting material on a substrate;

FIG. 2 illustrates a connection between an actuator arm and a substrate;

FIG. 3 illustrates another connection between an actuating arm and a substrate;

FIG. 4 illustrates yet another connection between an actuating arm and a substrate;

FIG. 5 illustrates yet another connection between an actuating arm and a substrate

FIG. 6 illustrates an actuating arm connected to a perforated tray supporting a plurality of substrates; and

FIG. 7 is a flow diagram of one disclosed method for dip coating a superconducting coating on a substrate.

### DETAILED DESCRIPTION OF THE PRESENTLY PREFERRED EMBODIMENTS

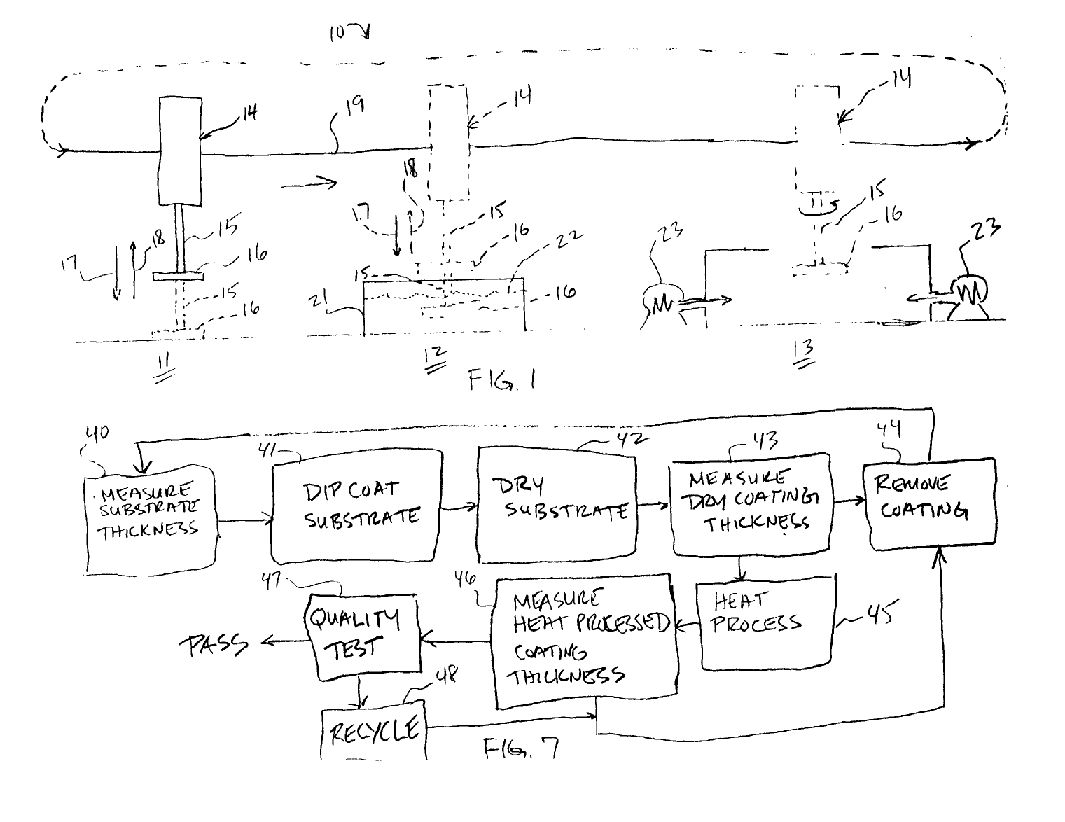

Turning to FIG. 1., a schematic illustration of an automated system for dip coating a superconducting coating on a substrate is disclosed. The system 10 includes a pick station 11, a dip coating station 12 and a drying station 13. An actuator 14 includes a retractable arm 15 that can be detachably connected to a substrate 16. At the pick up station 11, the arm 15 extends downward in the direction of the arrow 17 to engage the substrate 16 (as shown in phantom in FIG. 1) and is then retracted upward in the direction of the arrow 18 before the conveyor 19 transports the actuator 14 and substrate 16 to the dip coating station 12.

The dip coating station 12 includes a reservoir 21 containing a dip coating formulation 22. At the dip coating station 12, the actuator 14 moves the arm downward in the direction of the arrow 17 to submerse the substrate 16 in the dip coating formulation 22. Before retracting the arm 15 upward in the direction of the arrow 18 to remove the now dip-coated substrate 16 from the dip coating formulation 22. After the substrate 16 is removed from the dip coating formulation 22, the conveyor 19 transports the actuator 14 and substrate 16 to the drying station 13. At the drying station 13, the arm 15 and substrate 16 are lowered to an appropriate height so that hot air provided by the blowers/heaters 23 circulates around the substrate to dry the superconducting coating.

In a preferred embodiment, the actuator 14 is capable of rotating the arm 15 and therefore the substrate 16 during the drying process. While rotational rates will vary depending upon the particular substrate and dip coating ink formulation utilized, one suggested rotational speed is 300 rpm but the rotational speed may range generally anywhere from about 200 rpm to about 400 rpm.

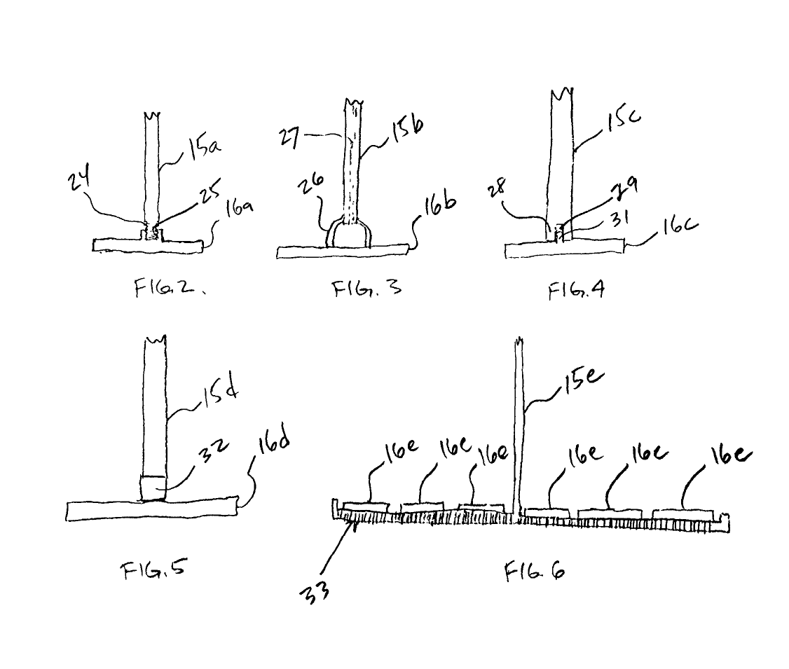

Numerous means for connecting the arm 15 to the substrate 16 are possible. In FIG. 2, an arm 15a includes a threaded distal end 24 which threadably engages a female threaded hole 25 in a substrate 16a. In FIG. 3, an arm 15b includes a suction cup 26 at its distal end and further includes a conduit 17 for withdrawing air from the suction cup 26 to provide a vacuum connection between the arm 15b and the substrate 16b. In FIG. 4, the arm 15c includes a distal end 28 with a hole 29 that frictionally receives an upwardly protruding stub 31 of the substrate 16c. In FIG. 5, the arm 15d includes a magnetized distal end 32 which magnetically engages the substrate 16d. In FIG. 6, the arm 15e is connected to a perforated tray 33 which supports a plurality of substrates 16e. Accordingly, a plurality of substrates 16e may be dip coated and dried contemporaneously.

FIG. 2 is a flow diagram illustrating various automated methods for dip coating superconducting materials on substrates. At step 40, the substrate thickness is measured before the substrate is transported via an actuator 14 to a dip coating station 12 where it is dip coated at step 41. The coated substrate is then transported via the actuator and conveyor 19 to a drying station 13 where the substrate is dried at step 42. After the drying step 42, the substrate thickness is again measured to thereby provide a dry coating thickness at step 43. If the dry coating thickness is unsatisfactory, the coating is removed from the substrate at step 44 and the process begins again at step 40. If the dried coating thickness is satisfactory, the substrate is then heat processed at step 45. The heat processing can be a sintering process or a melt processing or melt texturing process as well as another suitable heat process. After the heat process step 45, the coating or substrate thickness is then measured again at step 46 and, if the coating is of a satisfactory thickness, the coating quality is tested at step 47. If the substrate fails the quality test, it is recycled at step 48 by removing the coating. Similarly, if the thickness of the coating is proven unsatisfactory at step 46, the coating is then removed at step 44 as shown in FIG. 7.

One formulation for dip coating substrates, including three dimensional substrates and other substrates, includes a vehicle mixed with phase pure YBCO powder so that the formulation comprises from about 62 wt % to about 64 wt % phase pure YBCO powder and from about 36 wt % to about 38 wt % of a vehicle. The vehicle comprises from about 57 wt% to about 59 wt % terpineol, from about 37 wt % to about 39 wt % butoxyethyl acetate and from about 2 wt % to about 5 wt % binder. The terpineol and butoxyethyl acetate serve as solvents. The terpineol is preferably alpha-terpineol and the butoxyethyl acetate is preferably 2-butoxyethyl acetate. The preferred binders are acryloid, more preferably B-67™ acryloid and cellulose, more preferably a combination of T-200™ cellulose, N4™ cellulose and Ehec-Hi™ cellulose. Preferably, the vehicle and the dip coating formulation are free of dispersants as they are deemed unnecessary.

One preferred formulation utilizing phase pure YBCO powder is as follows:

| | Preferred Weight % |
|---|---|
| Vehicle | |
| Alpha-terpineol | 57.85 |
| 2-Butoxyethyl acetate (a.k.a. “BCA”) | 38.61 |
| B-67 ™ acryloid (a.k.a. “paraloid”) | 1.58 |
| T-200 ™ ethylcellulose | 0.65 |
| Ehec-Hi ™ cellulose | 0.59 |
| N4 ™ cellulose | 0.72 |
| Phase Pure Dip Coating Ink Formulation | |
| Phase pure YBa₂Cu₃O₆₊ₓ powder | 63 |
| Vehicle | 37 |

Another formulation for dip coating substrates includes a vehicle mixed with unreacted YBCO precursor powder so that the formulation comprises from about 71 wt % to about 73 wt % unreacted YBCO precursor powder and from about 27 wt % to about 29 wt % of a vehicle. The vehicle comprises from about 47 wt % to about 49 wt % terpineol, from about 47 wt % to about 49 wt % butoxyethyl acetate and from about 2 wt % to about 4 wt % of a binder. The unreacted YBCO precursors include Y₂O₃, BaCO₃ and CuO. The terpineol and butoxyethyl acetate serve as solvents. The terpineol is preferably alpha-terpineol and the butoxyethyl acetate is preferably 2-butoxyethyl acetate. The preferred binders are acryloid, more preferably B-67™ acryloid and cellulose, more preferably T-200™ cellulose. Preferably, the vehicle and the dip coating formulation are free of dispersants as they are deemed unnecessary. The disclosed process and formulation are especially adaptable for use on yttria (partially stabilized) zirconia substrates.

One preferred YBCO precursor formulation is as follows:

| | Preferred Weight % |
|---|---|
| Vehicle | |
| Alpha-terpineol | 48.72 |
| 2-Butoxyethyl acetate (a.k.a. “BCA”) | 48.72 |
| B-67 ™ acryloid (a.k.a. “paraloid”) | 1.28 |
| T-200 ™ ethylcellulose | 1.28 |
| YBCO Precursor Dip Coating Ink Formulation | |
| unreacted YBa₂Cu₃O₆₊ₓ Precursor | 72 |
| (a.k.a. “YBCO precursor”) | |
| Vehicle | 28 |

Generally, the solvents content control the viscosity. Accordingly, when alpha-terpineol is chosen as a solvent, if too much alpha-terpineol is provided, the ink formulation can be too thin, resulting in a film that is too thin. If an insufficient amount of alpha-terpineol is provided, the ink formulation can be too viscous resulting in a film that is too thick. Similarly, if butoxyethyl acetate is chosen as a solvent, if too much butoxyethyl acetate is provided, the ink formulation can be too thin, resulting in a film that is too thin. If an insufficient amount of butoxyethyl acetate is provided, the ink formulation can be too viscous resulting in a film that is too thick.

If the binder or binders are present in too great of an amount, the resulting ink formulation is too viscous and the resulting film can be too thin. If the binder or binders are present in an insufficient amount, the unfired film is too weak resulting in poor adhesion to the substrate.

Accordingly, when T-200™ ethylcellulose is chosen as a binder, if the T-200™ ethylcellulose is present in too great of an amount, the resulting ink formulation is too viscous and the resulting film can be too thin. If the T-200™ ethylcellulose is present in an insufficient amount, the unfired film is too weak resulting in poor adhesion to the substrate.

When N4™ cellulose is chosen as a binder, if the N4™ cellulose is present in too great of an amount, the resulting ink formulation is too viscous and the resulting film can be too thin. If the N4™ cellulose is present in an insufficient amount, the unfired film is too weak resulting in poor adhesion to the substrate.

When Ehec-Hi™ cellulose is chosen as a binder, if the Ehec-Hi™ cellulose is present in too great of an amount, the resulting ink formulation is too viscous and the resulting film can be too thin. If the Ehec-Hi™ cellulose is present in an insufficient amount, the unfired film is too weak resulting in poor adhesion to the substrate.

Similarly, if too much vehicle is added to the dip coating formulation, the resultant ink or formulation is too thin and the viscosity can be unsatisfactorily low, thereby resulting in a coating that is too thin. If the vehicle is added in an insufficient amount, the resultant formulation or ink is too thick, resulting in a coating that can be unacceptably thick.

If the phase pure YBCO powder is present in too great of an amount, the resultant ink formulation can be too viscous resulting in an unfired film that is weak. If the phase pure YBCO powder is present in an insufficient amount, the ink can be too thin or have an insufficient viscosity resulting in a fired film that is too thin.

If the YBCO precursor is present in too great of an amount, the resultant ink formulation can be too viscous resulting in an unfired film that is weak. If the unreacted YBCO precursor is present in an insufficient amount, the ink can be too thin or have an insufficient viscosity resulting in a fired film that is too thin.

Combinations of other solvents in addition to alpha-terpineol and butoxyethyl may also be utilized. Binders other than B-67™ acryloid, T-200™ ethylcellulose, N4™ cellulose and Ehec-Hi™ cellulose may also be utilized.

In creating the YBCO precursor vehicle for the phase pure formulation, the solids, i.e., the B-67™ acryloid, T-200™ ethylcellulose, N4™ cellulose and Ehec-hi™ cellulose are dissolved in the alpha-terpineol and 2-butoxyethyl acetate. Then, the YBCO precursors mixed with the resulting vehicle to produce an ink. A substrate, such as a silver plated PYROMET™ (INCONEL™ 600™) substrate, is then dipped into the dip ink formulation, removed and dried. The drying process can be carried out a temperature of about 90° C. During the drying process, the substrate can be rotated. Finally, the substrate is sintered. The sintering is carried out by heating the substrate at a rate of about 300° C. per hour to a temperature of about 840° C. and holding the substrate at that first temperature for about one hour. The heating and holding steps are preferably carried out in a 1% oxygen atmosphere. The substrate is then cooled at a rate of about 300° C. per hour to a temperature of about 700° C. in a pure oxygen atmosphere followed by further cooling at a rate of about 60° C. per hour to a temperature of about 300° C., again in a pure oxygen atmosphere, followed by faster cooling at a rate of about 300° C. per hour to room temperature, again in a pure oxygen atmosphere.

A preferred viscosity range for the phase pure vehicle is from about 50 cPs to about 75 cPs at 100 s⁻¹, preferably about 68 cPs at 100 s⁻¹. The viscosity of the resulting phase pure dip coating formulation or ink preferably ranges from about 200 cPs to about 270 cPs at 100 s⁻¹, preferably about 247 cPs at 100 s⁻¹. The viscosity measurements were made with a BROOKFIELD™ viscometer.

Three different phase pure YBCO powders are currently preferred. Two powders are supplied by Praxair, Inc. (Praxair phase pure with a d50<4.1 and Praxair phase pure with a d50<2). Another phase pure YBCO powder is provided by Marketech International, Inc.

In creating the YBCO precursor vehicle, the solids, i.e., the B-67™ acryloid and T-200™ ethylcellulose are dissolved in the alpha-terpineol and 2-butoxyethyl acetate. Then, the YBCO precursor is mixed with the resulting vehicle to produce an ink. A substrate, such as yttria (partially stabilized zirconia) substrate, is then dipped into the dip ink formulation, removed and dried. The drying process can be carried out a temperature of about 90° C. During the drying process, the substrate can be rotated. Finally, the substrate is melt processed. The melt processing is carried out by heating the substrate at a rate of about 300° C. per hour to a temperature of about 1050° C. and holding the substrate at that first temperature for about six minutes. The heating and holding steps are preferably carried out in a pure oxygen atmosphere. The substrate is then cooled at a rate of about 120° C. per hour to a temperature of about 300° C. in a pure oxygen atmosphere followed by further cooling at a faster rate of about 300° C. per hour to room temperature, again in a pure oxygen atmosphere. Variations of the melt processing procedure disclosed in U.S. Pat. Nos. 5,789,347 and 6,119,205 may also be employed.

A preferred viscosity range for the precursor vehicle is from about 40 cPs to about 65 cPs at about 100 s⁻¹, preferably about 50 cPs 100 s⁻¹. The viscosity of the resulting YBCO precursor dip coating formulation or ink preferably ranges from about 2100 cPs to about 2500 cPs at 20 s⁻¹, preferably about 2400 cPs at 20 s⁻¹. The viscosity values are also taken with a BROOKFIELD™ viscometer.

The foregoing detailed description has been given for clearness of understanding only, and no unnecessary limitations should be understood therefrom, as modifications would be obvious to those skilled in the art.

What is claimed:

1. An automated system for dip coating a superconducting material on a substrate, the system comprising:
an actuator,
a pickup station,
a dip coating station comprising a reservoir of a dip coating formulation,
a drying station comprising a source of heated air, and
a conveyor for moving the actuator from the pickup station to the dip coating station and from the dip coating station to the drying station,
the actuator comprising an arm for carrying a substrate, the arm capable of being moved vertically downward to submerse the substrate in the dip coating reservoir and being moved vertically upward to lift the substrate out of the dip coating reservoir.

2. The system of claim 1 wherein the actuator arm is capable of rotating the substrate.

3. The system of claim 2 wherein the actuator arm rotates the substrate while holding the substrate in the drying station.

4. The system of claim 1 wherein the drying station comprises an enclosure for circulating heated air for drying the substrate.

5. The system of claim 1 wherein the actuator comprises a hydraulic mechanism for vertically raising and lowering the arm.

6. The system of claim 1 wherein the conveying mechanism comprises an endless belt detachably connected to the actuator for conveying the actuator from pickup station to the dip coating station and from the dip coating station to the drying station.

7. The system of claim 1 wherein the conveying mechanism comprises an endless chain detachably connected to the actuator for conveying the actuator from pickup station to the dip coating station and from the dip coating station to the drying station.

8. The system of claim 1 wherein the arm is detachably connected to a perforated tray that supports a plurality of substrates.

9. The system of claim 1 wherein the arm threadably engages the substrate.

10. The system of claim 1 wherein the arm magnetically engages the substrate.

11. The system of claim 1 wherein the arm suctionally engages the substrate.

12. The system of claim 1 wherein the arm frictionally engages the substrate.

13. The system of claim 1 wherein the substrate is a silver plated steel substrate.

14. The system of claim 1 wherein the substrate is a yttria partially stabilized zirconia substrate.

15. The system of claim 1 wherein the dip coating formulation comprises:
from about 62 to about 64 wt % phase pure YBa₂Cu₃O₆₊ₓ powder and from about 36 to about 38 wt % vehicle,
the vehicle comprising
from about 57 wt % to about 59 wt % terpineol, from about 37 wt % to about 39 wt % butoxyethyl acetate, and from about 2 wt % to about 5 wt % binder.

16. The system of claim 1 wherein the dip coating formulation consists essentially of:
about 63 wt% phase pure YBa₂Cu₃O₆₊ₓ powder and about 37 wt % vehicle, the vehicle consisting essentially of
from about 57 wt% to about 59 wt% alpha-terpineol,
from about 37 wt% to about 39 wt% 2-butoxyethyl acetate,
from about 0.3 wt% to about 0.9 wt% B-67 acryloid,
from about 0.4 wt% to about 0.8 wt% T-200™ cellulose and
from about 0.5 wt% to about 0.9 wt% N4™ cellulose.

17. The system of claim 1 wherein the dip coating formulation comprises:
from about 71 wt % to about 73 wt % unreacted YBa₂Cu₃O₆₊ₓ precursor powder and from about 27 wt % to about 29 wt % vehicle,
the vehicle comprising
from about 47 wt% to about 49 wt% terpineol,
from about 47 wt% to about 49 wt% butoxyethyl acetate, and
from about 2 wt% to about 4 wt% of a binder.

18. The system of claim 1 wherein the dip coating formulation consists essentially of:
about 72 wt % unreacted YBa₂Cu₃O₆₊ₓ precursor powder and about 28 wt % vehicle,
the vehicle consisting essentially of
from about 47 wt% to about 49 wt% alpha-terpineol,
from about 47 wt% to about 49 wt% 2-butoxyethyl acetate,
from about 1 wt% to about 2 wt% B-67™ acryloid, and
from about 1 wt% to about 2 wt% T-200™ cellulose.

19. The system of claim 1 wherein the drying station maintains an air temperature of about 90° C.

20. The system of claim 1 wherein the actuator rotates the substrate in the drying station at a rate ranging from about 200 rpm to about 400 rpm.

21. The system of claim 1 wherein the actuator rotates the substrate in the drying station at a rate of about 300 rpm.

22. A method of dip coating a superconductor coating on a substrate, the method comprising:
picking up a substrate at a pickup station, the substrate having a first thickness,
conveying the substrate to a dip coating station comprising a reservoir of a dip coating formulation,
submersing the substrate in the reservoir of dip coating formulation to form a coating thereon,
removing the substrate from the reservoir,
conveying the substrate to a drying station comprising a source of heated air,
drying the coating of the substrate in the drying station, the coating having a second thickness after the drying step, and
heat processing the substrate to provide a processed coating having a third thickness.

23. The method of claim 22 further comprising measuring the second thickness of the coating after the drying step.

24. The method of claim 22 further comprising measuring the second thickness of the coating after the heat processing step.

25. The method of claim 22 further comprising measuring the first thickness of the substrate before the submersing step and measuring the second thickness of the coating after the drying step and, if the second thickness of the coating is unsatisfactory, removing the coating from the substrate and performing the method again.

26. The method of claim 22 further comprising measuring the first thickness of the substrate before the submersing step and measuring the third thickness of the coating after the heat processing step and, if the second thickness of the coating is unsatisfactory, removing the coating from the substrate and performing the method again.

27. The method of claim 22 further comprising measuring the first thickness of the substrate before the submersing step, measuring the second thickness of the coating after the drying step, measuring the third thickness of the coating after the heat processing step and, if the second or third thicknesses of the coating is unsatisfactory after either the drying or heat processing steps, removing the coating from the substrate and performing the method again.

28. The method of claim 22 wherein the heat processing step comprises sintering the substrate.

29. The method of claim 22 wherein the heat processing step comprises melt processing the substrate.

30. The method of claim 22 wherein the dip coating formulation comprises:
from about 62 to about 64 wt % phase pure YBa₂Cu₃O₆₊ₓ powder and from about 36 to about 38 wt % vehicle,
the vehicle comprising
from about 57 wt % to about 59 wt % terpineol,
from about 37 wt % to about 39 wt % butoxyethyl acetate, and
from about 2 wt % to about 5 wt % binder.

31. The method of claim 22 wherein the dip coating formulation consists essentially of:
about 63 wt % phase pure YBa₂Cu₃O₆₊ₓ powder and about 37 wt % vehicle,
the vehicle consisting essentially of
from about 57 wt % to about 59 wt % alpha-terpineol,
from about 37 wt % to about 39 wt % 2-butoxyethyl acetate,
from about 0.3 wt % to about 0.9 wt % B-67 acryloid,
from about 0.4 wt % to about 0.8 wt % T-200™ cellulose and
from about 0.5 wt % to about 0.9 wt % N4™ cellulose.

32. The method of claim 22 wherein the dip coating formulation comprises:
from about 71 wt % to about 73 wt % unreacted YBa₂Cu₃O₆₊ₓ precursor powder and from about 27 wt % to about 29 wt % vehicle,
the vehicle comprising
from about 47 wt % to about 49 wt % terpineol,
from about 47 wt % to about 49 wt % butoxyethyl acetate, and
from about 2 wt % to about 4 wt % of a binder.

33. The method of claim 22 wherein the dip coating formulation consists essentially of:
about 72 wt % unreacted YBa₂Cu₃O₆₊ₓ precursor powder and about 28 wt % vehicle,
the vehicle consisting essentially of
from about 47 wt % to about 49 wt % alpha-terpineol,
from about 47 wt % to about 49 wt % 2-butoxyethyl acetate,
from about 1 wt % to about 2 wt % B-67™ acryloid, and
from about 1 wt % to about 2 wt % T-200™ cellulose.

34. The method of claim 22 wherein the drying step is carried out at about 90° C.

35. The method of claim 22 wherein the drying step further comprises rotating the substrate at a rate ranging from about 200 rpm to about 400 rpm.

36. The method of claim 22 wherein the drying step further comprises rotating the substrate at a rate of about 300 rpm.

37. The method of 28 wherein the sintering comprises heating the substrate to a first temperature exceeding 800° C. at a first rate in a low oxygen content atmosphere and holding the substrate at the first temperature for about ½ hour to about 1 ½ hours, cooling the substrate in a substantially pure oxygen atmosphere at a second rate to a second temperature, cooling the substrate in a substantially pure oxygen atmosphere to a third temperature at a third rate that is slower than the second rate, and cooling the substrate in a substantially pure oxygen atmosphere to room temperature.

38. The method of claim 37 wherein the substrate is held at the first temperature for about one hour.

39. The method of claim 37 wherein the first rate is about 300° C. per hour.

40. The method of claim 37 wherein the second rate is about 300° C. per hour.

41. The method of claim 37 wherein the third rate is about 60° C. per hour.

42. The method of 28 wherein the sintering comprises heating the substrate to a first temperature exceeding 1000° C. at a first rate in a low oxygen content atmosphere and holding the substrate at the first temperature for a time period of about 3 to about 10 minutes, cooling the substrate in a substantially pure oxygen atmosphere at a second rate that is slower than the first rate to a second temperature, cooling the substrate in a substantially pure oxygen atmosphere to room temperature.
